(19) United States
(12) Patent Application Publication
(10) Pub. No.: US 2005/0274079 A1
(43) Pub. Date: Dec. 15, 2005

(54) Bonded bracket assembly

(76) Inventor: Thong Chim, Willowdale (CA)

Correspondence Address: CLARK HILL, P.C., 500 WOODWARD AVENUE, SUITE 3500, DETROIT, MI, 48226, US

(21) Appl. No.: 11/149,397

(22) Filed: Jun. 9, 2005

Related U.S. Application Data
(60) Provisional application No. 60/578,183, filed on Jun. 9, 2004.
(60) Provisional application No. 60/633,965, filed on Dec. 7, 2004.

(51) Int. Cl. E05F 11/48

(52) U.S. Cl. 49/375

(57) ABSTRACT

A bracket assembly for mounting a windowpane to a window regulator. The bracket assembly includes a bracket body having a thickness substantially equal to the thickness of the adjacent windowpane. A pair of spaced sidewalls extend from the bracket body, defining a channel so that a portion of the windowpane is enveloped therein. The bracket assembly includes an aperture in the bracket body, operable to receive a mounting structure on a lift plate mounted to the window regulator. An adhesive bond is applied to between at least one of the spaced sidewalls and the abutting portion of the windowpane to bond the bracket assembly to the windowpane.

### FIELD OF THE INVENTION

The invention relates to window regulators for motor vehicle doors. More specifically, the present invention relates to assemblies to mount a windowpane to the window regulator.

### BACKGROUND OF THE INVENTION

Motor vehicles side doors are typically equipped with a window regulator in order to raise or lower the side door windowpane. The windowpane must be securely mounted to the lifter plate on the window regulator in order to withstand the rigors of daily use. In addition, the windowpane should be easy to mount to the lifter plate, requiring a minimal amount of labor and parts to install. Also preferably, the windowpane should be convenient to remove from the window regulator should it need replacing.

Currently, laminated window glass cannot be effectively mounted directly to the lifter plate because holes cannot reliably be drilled in this type of glass without risk of breaking the glass or degrading its safety features. Instead, more elaborate (and expensive) methods have been used to mount the windowpane. One common technique is to use frictional clamps. An elastometric trim is typically placed around the clamping area to ensure a snug fit without cracking the glass. The elastometric trim is often bonded to the windowpane using an adhesive. For example, U.S. Pat. No. 5,050,348 to Kane et al. teaches the use of molding a channel-shaped gasket over an edge of a window panel. A bracket is slidably mounted over the gasket to retain the window panel. U.S. Pat. No. 5,199,217 to Rose teaches the use of a molded profile (preferably made out of plastic) that encapsulates the lower edge of the windowpane. The profile is molded directly onto the window glass. A connector piece is then wedged into a slot on the base of the profile and is further mounted to the lift plate of the window regulator, preferably by bonding the connector piece with adhesive. U.S. Pat. No. 4,776,132 to Gold teaches the use of notches in the opposite corners of the windowpane's bottom edge. An elastometric cap is mounted over the window glass in the region of the notch. The windowpane is then placed on a lifter plate. The windowpane abuts a sidewall extending perpendicular to the lifter plate. Preferably, an adhesive bond is applied between the sidewall and the windowpane. Tabs extending out from the sidewall are then bent over the electrometric cap so that the tabs wrap around the glass surface opposite the sidewall.

Windowpanes can also be mounted using adjustable brackets. For example, U.S. Pat. No. 5,907,927 to Lieb and Edwards (hereafter the '927 patent) teaches the use of an inner clip that is mounted around a base edge of the window panel. The inner clip can be spring-loaded and may also use an adhesive to bond to the window glass surface. The inner clip (holding the window panel) is then mounted within an outer jaw that is mounted to the lift member of the window regulator. The smaller inner jaws can be easily snapped around the window panel, and the complementary shapes of the inner and outer jaws allow a more accurate placement of the window panel. U.S. Pat. No. 6,330,764 to Klosterman (hereafter the '764 patent) also uses glass panels with notches in the opposing corners of the bottom edge. Clasping brackets engage the window glass over the notched corners of the window glass. The brackets are pivotally linked to a lifter plate on the window regulator. While these techniques may secure the window glass, they also require complicated parts that add to the cost of assembly.

It is desirable to provide a windowpane mounting that securely mounts the windowpane to a window regulator in an inexpensive fashion. It is further desirable to provide a windowpane mount that allows the windowpane to be quickly and easily replaced.

### SUMMARY OF THE INVENTION

It is an object of the invention to provide a bracket assembly for a windowpane that securely mounts the windowpane to a window regulator. According to an embodiment of the invention, there is provided a bracket assembly for mounting a windowpane having at least one indented region along the edge of the windowpane to a window regulator for a motor vehicle. The bracket assembly includes a bracket body abutting against the indented region, and a pair of spaced sidewalls extending from the bracket body. The pair of spaced sidewalls define a channel and a portion of the windowpane is mounted therein. An aperture is provided in the bracket body, operable to receive a mounting structure on a lift plate mounted to the window regulator. An adhesive bond is applied to between at least one of the spaced sidewalls and the abutting portion of the windowpane to bond the bracket assembly to the windowpane.

According to another embodiment of the invention there is provided a bracket assembly for mounting a windowpane without indented regions to a window regulator for a motor vehicle. The bracket assembly includes a bracket body abutting against the windowpane, having a thickness equal to the thickness of the adjacent windowpane, and a pair of spaced sidewalls extending out from the bracket body at opposing ends of the bracket assembly. The pair of spaced sidewalls define a channel and a portion of the windowpane is mounted therein. An aperture is provided in the bracket body that is displaced away from the windowpane and is operable to receive a mounting structure on a lift plate mounted to the window regulator. An adhesive bond is applied to between at least one of the spaced sidewalls and the abutting portion of the windowpane to bond the bracket assembly to the windowpane.

### DETAILED DESCRIPTION OF THE DRAWINGS

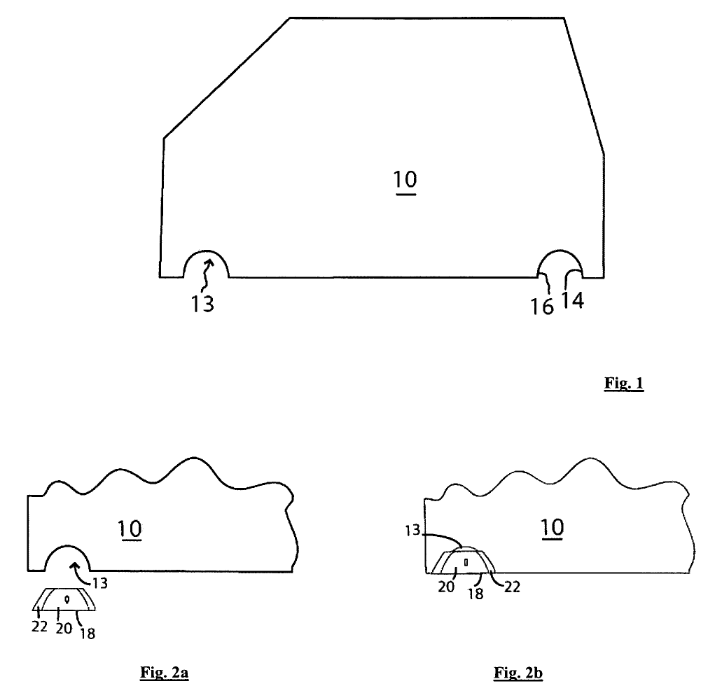

FIG. 1 shows a side-plan view of a laminated windowpane for a vehicle in accordance with an embodiment of the invention;

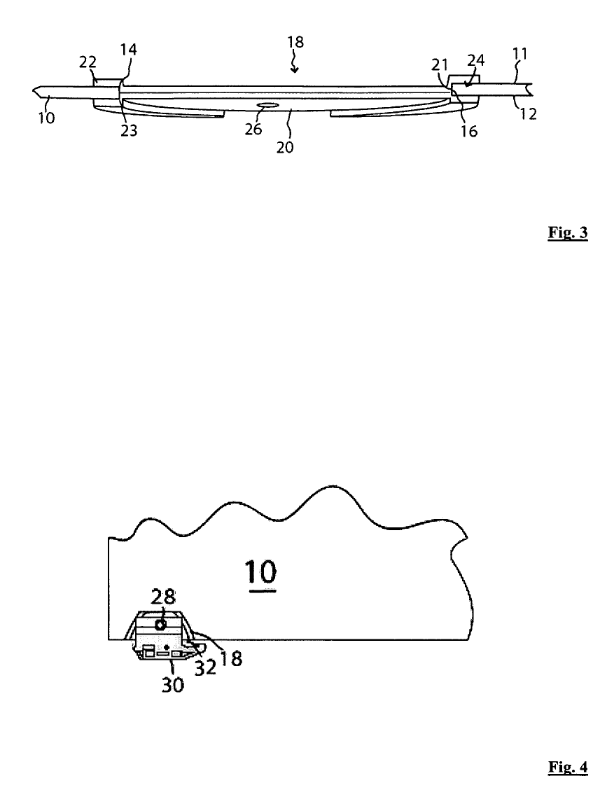

FIGS. 2a and 2b shows a side-plan view of the windowpane shown in FIG. 1, with a bracket assembly being mounted to the windowpane;

FIG. 3 shows a bottom plan view of the bracket assembly shown in FIG. 2b;

FIG. 4 shows a side plan view of the bracket assembly and windowpane shown in FIG. 2b mounted to a snap-in lift plate;

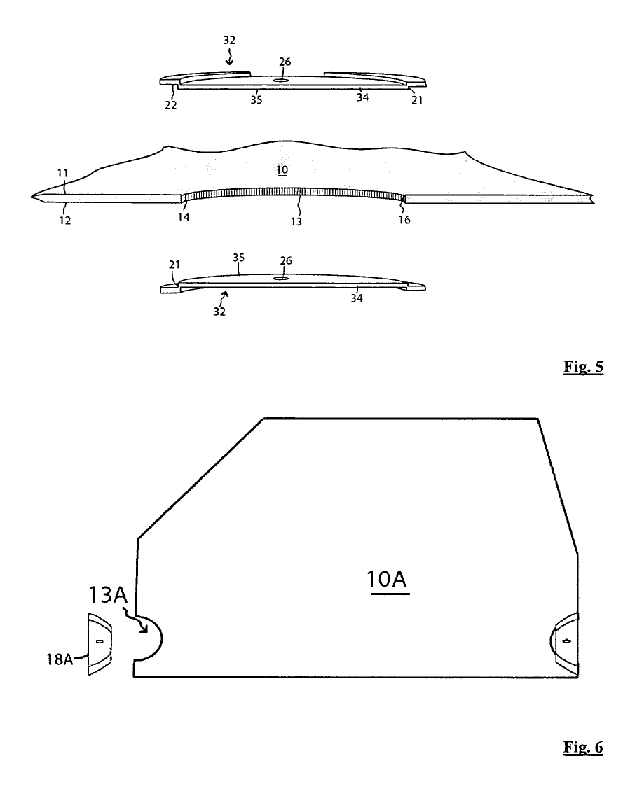

FIG. 5 shows an exploded view of the windowpane and bracket assembly shown in FIG. 2b;

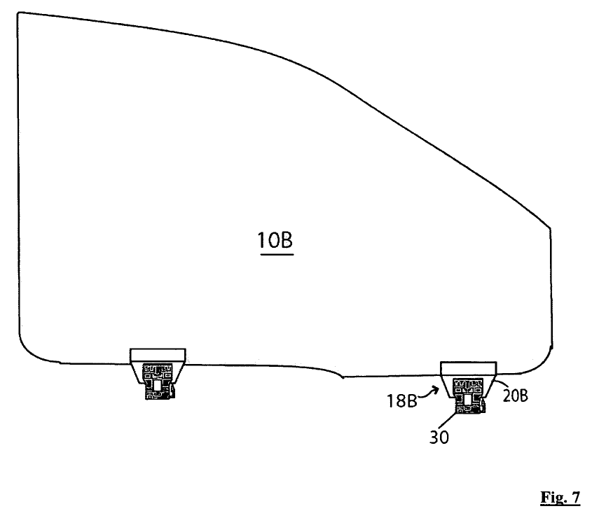

FIG. 6 shows a side-plan view of a laminated windowpane with a bracket assembly being mounted to the windowpane in accordance with a second embodiment of the invention; and

FIG. 7 shows a side-plan view of a laminated windowpane with bracket assemblies being mounted to the windowpane in accordance with a third embodiment of the invention.

### DETAILED DESCRIPTION OF THE INVENTION

Referring now to FIG. 1, a windowpane 10 for a motor vehicle side door is shown, having a first surface 11 and an opposing second surface 12 (FIG. 5). Preferably, windowpane 10 is made of laminated safety glass. Along a peripheral edge of windowpane 10, is a pair of contoured indented regions 13. In the presently preferred embodiment, intended regions 13 are located along the base edge of windowpane 10. Indented regions 13 can be made as part of the window glass forming process, or they can be later cut out of windowpane 10. While the present embodiment uses semi-circular indented regions, the size and shape of each indented region 13 is not particularly limited, and can include other indented shapes that can be formed or cut in windowpane 10. Each indented region 13 includes a first contoured surface 14 and a second contoured surface 16 on the opposite side of indented region 13.

Windowpane 10 is operable to be raised or lowered by a conventional window regulator (not shown). The type of window regulator is not particularly limited and it can include both single or dual rail window regulators, as well as scissor-type window regulators. The window regulator can be either motorized or manually powered. Referring now to FIGS. 2a, 2b and 3, a bracket assembly 18 for mounting windowpane 10 to the window regulator is shown. FIG. 2a shows bracket assembly 18 prior to being mounted over indented region 13 to windowpane 10, and FIG. 2b shows bracket assembly 18 after being mounted over indented region 13 to windowpane 10. Bracket assembly 18 can be manufactured from metal or a suitably resilient non-metal material such as plastic. Bracket assembly 18 includes a body portion 20 having a bracket edge 21 (FIG. 3) that has the same general shape and size as indented region 13, so that the bracket edge 21 is fitted against first contoured surface 14 and second contoured surface 16 of windowpane 10. Depending on the shape of bracket assembly 18, a slight gap may exist between the bracket edge 21 of body portion 20 and a portion of the edge of windowpane 10, between first contoured surface 14 and second contoured surface 16. As can be clearly seen in FIG. 3, the thickness of body portion 20 is the same as the thickness of windowpane 10 between first surface 11 and second surface 12. Preferably, body portion 20 fits entirely within indented region 13.

A pair of sidewalls 22 extends out from each of the opposing ends of body portion 20 via a web portion 23 of bracket assembly 18. The pair of sidewalls 22 form a channel 24, sized as to be complementary to the thickness of windowpane 10. Thus, when body portion 20 is placed within indented region 13, sidewalls 22 overlap opposite surfaces on windowpane 10, enveloping first contoured surface 14 and seconded contoured surface 16. An adhesive material (not shown) is applied between sidewalls 22 and the abutting portions of windowpane 10 as to firmly bond bracket assembly 18 to the window glass.

A mounting hole 26 (FIG. 3) is provided though the center of body portion 20. As can be seen in FIG. 4, with a mounted and bonded bracket assembly 18, windowpane 10 can be mounted directly to a post 28 on a snap-in lifter plate 30. Alternatively, a bolt or other mounting structure can be passed through mounting hole 26 and mounted to snap-in lifter plate 30. Spring tabs 32 on lifter plate 30 provide for additional guidance when mounting.

In operation, the window regulator (not shown) raises or lowers lifter plates 30, thereby raising or lowering bracket assemblies 18. When lifter plates 30 are raised, bracket assemblies 18 react against first contoured surface 14 to lift windowpane 10 and when lifter plates 30 are lowered, bracket assemblies 18 react against seconded contoured surface 16 to lower windowpane 10. Should windowpane 10 need to be replaced, bracket assemblies 18 are dismounted from snap in lifter plates 30 and windowpane 10 is removed from the window regulator (not shown). A new windowpane 10 with bonded bracket assemblies 18 can then be mounted.

In order to facilitate the manufacture of bracket assembly 18 and its subsequent mounting to windowpane 10, each bracket assembly 18 preferably comprises two symmetrical half plates 32. As can be seen in FIG. 5, one half plate 32 is mounted to windowpane 10 over first surface 1, and the other half plate 32 is mounted to windowpane 10 over second surface 12. Each half plate 32 includes a half body 34, along with one sidewall 22 of the pair of opposing sidewalls 22 at each end. The two half plates 32 are placed together so that a back surface 35 on one half body 34 aligns with a back surface 35 on the other half body 34 to form the complete bracket assembly 18. If the half plate 32 is produced through metal stamping then the material thickness of half body 34 should be half of the thickness of windowpane 10 so that when a symmetrical half plate 32 is placed on the opposite side of indented region 13, the thickness of body portion 20 is equivalent to the thickness of windowpane 10.

Alternatively, instead of using two half plates 32, bracket assembly 18 can be formed from a single plate. Forming is then required to achieve the same thickness as windowpane 10 in body portion 20 and to provide opposing pairs of sidewalls 22. As mentioned earlier, bracket assembly 18 can also be produced using non-metallic material such as plastic, using plastic molding. Using this methodology, one bracket assembly 18 can be used to encapsulate the laminated glass based on the same concept as above. Again, in this case the material thickness for body portion 20 should be equivalent to the thickness of windowpane 10.

While the above-described embodiment of the invention locates indented regions 13 along the peripheral edge that forms the lower base of windowpane 10, other locations for indented regions 13 are within the scope of the invention. Referring now to FIG. 6, a second embodiment of the invention is shown at 10A. Windowpane 10A has a pair of indented regions 13A located along opposing edges of the window glass. Other arrangements of indented regions 13 along the peripheral edges of windowpane 10 are within the scope of the invention.

It has also been contemplated that windowpane 10 could omit the indented regions 13 entirely. While this embodiment is less compact than the embodiment shown in FIG. 2, a window glass without indented regions can be used. Referring now to FIG. 7, a third embodiment of the invention is shown at 10B. Windowpane 10B lacks indented regions. Instead, a body portion 20B on bracket assembly 18B extends beyond windowpane 10B so that mounting hole 26B is displaced away from windowpane 10B.

1. A bracket assembly for mounting a windowpane to a window regulator for a motor vehicle, the bracket assembly comprising:
a bracket body abutting against an edge of the windowpane;
a pair of spaced sidewalls extending from the bracket body, the pair of spaced sidewalls defining a channel for enveloping a portion of the windowpane; and
an aperture in the bracket body, the aperture operable to receive a mounting structure on a lift plate mounted to the window regulator;
wherein an adhesive bond is applicable to at least one of the spaced sidewalls and the abutting portion of the windowpane to bond the bracket assembly to the windowpane.

2. The bracket assembly of claim 1, wherein the bracket body has a thickness substantially equal to the thickness of the adjacent windowpane.

3. The bracket assembly of claim 2, wherein the bracket assembly comprises:
a first half bracket plate having a body portion having a thickness substantially equal to one half the thickness of the windowpane, an aperture in the body portion and a sidewall portion extending from the body portion and abutting against a portion of a first side of the windowpane;
a second half bracket plate having a body portion having a thickness substantially equal to one half the thickness of the windowpane, an aperture in the body portion and a sidewall portion extending from the body portion and abutting against a portion of a second side of the windowpane; and
wherein mounting the first half bracket plate on the first side of the windowpane and mounting the second half bracket plate on the second side of the windowpane axially aligns the apertures on the first half bracket plate and the second half bracket plate.

4. The bracket assembly of claim 2, wherein the windowpane includes at least one indented region on the edge of the windowpane and the bracket body abuts against the edge of the windowpane in the indented region.

5. The bracket assembly of claim 4, wherein the at least one indented region includes two indented regions on the edge of the windowpane, and a bracket assembly is mounted to the windowpane around each of the indented regions.

6. The bracket assembly of claim 4, wherein the at least one indented region includes two indented regions on opposing edges of the windowpane, and a bracket assembly is mounted to the windowpane around each of the indented regions.

7. The bracket assembly of claims 1-6, wherein the lifter plate is a snap-in lifter plate and the mounting structure is a post depending from the snap-in lifter plate.

8. The mounting assembly of claim 7, wherein the windowpane is made of laminated safety glass.
